(19) United States
(12) Patent Application Publication
(10) Pub. No.: US 2022/0399574 A1
(43) Pub. Date: Dec. 15, 2022

(54) ELECTROLYTE FOR LITHIUM METAL BATTERIES

(71) Applicant: GM GLOBAL TECHNOLOGY OPERATIONS LLC, Detroit, MI (US)

(72) Inventors: Umamaheswari Viswanathan, Troy, MI (US); Li Yang, Troy, MI (US); Vijay P. Saharan, Grand Blanc, MI (US); Mary E. Fortier, Troy, MI (US)

(73) Assignee: GM GLOBAL TECHNOLOGY OPERATIONS LLC, Detroit, MI (US)

(21) Appl. No.: 17/304,134

(22) Filed: Jun. 15, 2021

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2300/0034; H01M 2220/20

(57) ABSTRACT

An electrolyte solution for a lithium metal battery is provided. The electrolyte solution includes lithium bis(fluorosulfonyl)imide dissolved in a fluorinated ether solvent. The electrolyte solution further includes a first additive including fluoroethylene carbonate and a second additive including lithium difluorophosphate. In one embodiment, the fluorinated ether solvent includes fluorinated 1,4 dimethoxy butane.

### INTRODUCTION

The disclosure generally relates to an electrolyte solution for lithium metal batteries, a lithium metal battery including an electrolyte solution, and a vehicular system operable by lithium metal battery including an electrolyte solution.

A lithium metal battery cell includes an anode and a cathode. A separator is disposed between the anode and the cathode. An electrolyte solution or a liquid including an electrolyte is provided surrounding the anode, the cathode, and the separator. When the battery cell is being used in a discharge mode, lithium ions are transferred through the electrolyte solution from the anode to the cathode, and electrical energy is discharged and flows from a first conductive terminal connected to the anode, through a discharge circuit, and to a second conductive terminal connected to the cathode. When the battery cell is being used in a charge mode, a charge current is applied to the battery cell, and lithium ions are transferred from the cathode to the anode through the electrolyte solution.

### SUMMARY

An electrolyte solution for a lithium metal battery is provided. The electrolyte solution includes lithium bis(fluorosulfonyl)imide dissolved in a fluorinated ether solvent. The electrolyte solution further includes a first additive including fluoroethylene carbonate and a second additive including lithium difluorophosphate.

In some embodiments, the fluorinated ether solvent is selected from one of fluorinated 1,4 dimethoxy butane; 1,1,2,2-tetrafluoroethyl 2,2,3,3-tetrafluoropropyl ether; 1,2,2,2-tetrafluoroethyl methyl ether; n-Butyl 1,1,2,2-tetrafluoroethyl ether; 1H,1H,2′H,3H-Decafluorodipropyl ether; bis(2,2,2-trifluoroethyl) ether; ethyl 1,1,2,2-tetrafluoroethyl ether; difluoromethyl 2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl) ether; 1,1,2,2-tetrafluoroethyl isobutyl ether; and 1,2-(1,1,2,2-tetrafluoroethoxy)-ethane.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

In some embodiments, the electrolyte solution further includes lithium hexafluorophosphate.

According to an alternative embodiment, a lithium metal battery is provided. The lithium metal battery includes an anode, a cathode, and a separator disposed between the anode and the cathode. The lithium metal battery further includes an electrolyte solution. The electrolyte solution includes lithium bis(fluorosulfonyl)imide dissolved in a fluorinated ether solvent, a first additive including fluoroethylene carbonate, and a second additive including lithium difluorophosphate.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

According to an alternative embodiment, a vehicular system operable by lithium metal battery is provided. The vehicular system includes an electrically powered vehicle and the lithium metal battery providing electrical energy to the electrically powered vehicle. The lithium metal battery includes an electrolyte solution. The electrolyte solution includes lithium bis(fluorosulfonyl)imide dissolved in a fluorinated ether solvent, a first additive including fluoroethylene carbonate, and a second additive including lithium difluorophosphate.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

The above summary is not intended to represent every embodiment or every aspect of the present disclosure. Rather, the foregoing summary merely provides an exemplification of some of the novel concepts and features set forth herein. The above features and advantages, and other features and advantages, will be readily apparent from the following detailed description of illustrated embodiments and representative modes for carrying out the disclosure when taken in connection with the accompanying drawings and appended claims. Moreover, this disclosure expressly includes any and all combinations and sub-combinations of the elements and features presented above and below.

### BRIEF DESCRIPTION OF THE DRAWINGS

FIG. 1 schematically illustrates a lithium metal battery cell including an electrolyte solution, in accordance with the present disclosure;

FIG. 2 schematically illustrates in side view a vehicle system including a plurality of lithium metal battery cells, in accordance with the present disclosure; and

FIG. 3 is a graph illustrating performance of the electrolyte solution, in accordance with the present disclosure.

### DETAILED DESCRIPTION

An electrolyte solution for use in a lithium metal battery is described. The electrolyte solution includes fluorinated ethers, otherwise described in the art as fluoroethers, including fluorinated 1,4 dimethoxy butane (FDMB) solvent. Throughout the disclosure, the terms fluorinated ethers and fluoroethers are used interchangeably. The electrolyte solution further includes fluoroethylene carbonate (FEC) solvent additive, and lithium difluorophosphate (LFO). Fluoroethers provide the electrolyte solution with non-flammable properties. Further, the fluoroether solvent provides corrosion prevention for an aluminum current collector. The FEC solvent improves conductivity of the electrolyte solution. The LFO provides excellent stability on a cathode electrolyte interphase (CEI).

The fluoroether may be provided as a solvent and from 0.5 M (molar) to 4 M (molar) lithium bis(fluorosulfonyl)imide (LiFSI) may be provided as a salt. In one embodiment, the fluoroether may be provided as a solvent and 1 M LiFSI may be provided as a salt. The fluoroether, such as FDMB, is provided as a solvent to provide oxidative stability as well as Li cycling efficiency. Using the fluoroether solvent takes advantage of a robust alkyl chain while simultaneously providing an ability to solvate Li salt and conduct Li⁺ ions. The fluoroether solvent provides —F groups relatively distant from —O— groups as compared to similar molecules such as 1,2 dimethoxyethane (DME), thereby enabling the described solvation ability.

Non-flammable properties of fluoroethers provide enhanced stability as compared to solvents without non-flammable properties. That is, fluoroethers may offer excellent non-flammability. Additionally, repeated charging cycles of a lithium metal battery cell including some electrolytes may cause lithium dendrites, or tiny structures, to form on the surface of a lithium anode. As these dendrites grow, they may pierce the separator within the battery cell and cause a short circuit within the battery. Utilizing 1 M LiFSI/Fluoroether, dendrite growth may be inhibited, preventing disruption of the separator and thereby providing non-flammable properties to the battery cell.

Some electrolyte solutions may include solvent molecules prone to causing corrosion of an aluminum current collector through electrochemical oxidation, in particular, with uses at increasing voltages. Organic radical cations may be generated from the electrochemical oxidation. These organic radical cations are energetically unstable and undergo a deprotonation reaction, generating protons and promoting dissolution of Al³⁺ from the aluminum current collector. One exemplary solvent/salt combination, 1 M LiFSI/DME, demonstrates a relatively low oxidation voltage of approximately 3.9 V (Volts). Using fluoroethers such as FDMB as a solvent prevents or resists this corrosion. 1 M LiFSI/fluoroether demonstrates a relatively high oxidation voltage of approximately or above 6 V, thereby providing increased lifespan of the aluminum current collector. In addition, solvent structures with a displaceable fluorine atom can form a stable AlF₃ molecule and offer corrosion protection.

In addition to or in the alternative to FDMB, other fluoroether solvents may be utilized in the electrolyte solution. Exemplary fluoroether solvents include 1,1,2,2-tetrafluoroethyl 2,2,3,3-tetrafluoropropyl ether; 1,2,2,2-tetrafluoroethyl methyl ether; n-Butyl 1,1,2,2-tetrafluoroethyl ether; 1H,1H,2′H,3H-Decafluorodipropyl ether; bis(2,2,2-trifluoroethyl) ether; ethyl 1,1,2,2-tetrafluoroethyl ether; difluoromethyl 2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; 1,1,2,2-tetrafluoroethyl isobutyl ether; and 1,2-(1,1,2,2-tetrafluoroethoxy)-ethane (TFE).

Use of FDMB as a solvent provides positive benefits. However, FDMB has decreased conductivity as compared to other similar solvents. In order to counter this decreased conductivity, FEC may be provided as an additive solvent in order to provide increased conductivity due to its high dielectric constant. A dielectric constant of a substance is defined as a ratio of electric permittivity or electric permeability of the substance to the electric permittivity or electric permeability of a vacuum. The dielectric constant of FEC is 107. By comparison to other similar solvents, dimethyl carbonate (DMC) has a dielectric constant of 3.11; ethyl methyl carbonate (EMC) has a dielectric constant of 2.96; diethyl carbonate (DEC) has a dielectric constant of 2.81; ethylene carbonate (EC) has a dielectric constant of 89.78; and propylene carbonate has a dielectric constant of 64.9. The high conductivity of FEC improves the overall conductivity of the electrolyte solution of the disclosed battery cell.

Chemical reactions taking place within the battery between the electrodes and the electrolyte solution cause a solid layer to form upon the electrodes. This solid layer is described as a solid electrolyte interphase (SEI). The SEI upon the cathode is described as a cathode electrolyte interphase (CEI). The SEI provides ionic conductivity and prevents electrolyte decomposition. Moreover, the addition of LFO increases the anodic stability of the salt. Battery cell operation, in particular, cycling stability of the battery cell, benefits from a stable SEI. The disclosed electrolyte solution may include lithium difluorophosphate (LiPO₂F₂, herein referred to as LFO) as a salt/an additive to stabilize the SEI upon the cathode and the anode. Presence of LFO results in fluorophosphate species being present in formation of the SEI, resulting in lower parasitic reaction rates between the electrodes and the electrolyte, excellent cell lifetime, and decreased cell impedance as compared to SEI formulation without the presence of LFO. As a result, a lithium metal battery device utilizing an electrolyte solution including LFO may exhibit increased charging cycle stability.

Lithium hexafluorophosphate (LiPF₆) is described as a salt that may be used in an electrolyte solution for a lithium metal battery. LiFSI is provided as an excellent salt for use in the disclosed electrolyte solution, providing increase thermal stability as compared to LiPF₆. LiFSI may be used (in combination with the LFO additive, described herein) as the salt in the disclosed electrolyte solution. LiFSI may alternatively be used in combination with LiPF₆ (in combination with the LFO additive, described herein) as the salt in the disclosed electrolyte solution. LFO is similar to LiPF₆ in terms of electrochemical stability, with similar highest occupied molecular orbital (HOMO) and lowest unoccupied molecular orbital (LUMO) energies and experimental potentials.

In one embodiment, the disclosed electrolyte solution may be described as 0.5 M (molar) to 4 M LiFSI−[fluoroether solvent] (1%-99%)/0.1%-5% LFO/0.1%-40% FEC (by weight %). Presence of substances outside of the provided ranges may lead to the substances failing to be present in sufficient concentrations to have the desired effects or may cause the electrolyte solution to be suboptimal for electrical energy transfer. In another embodiment, the disclosed electrolyte solution may be described as 1 M LiFSI−FDMB/0.5%-2% LFO/1%-2% FEC.

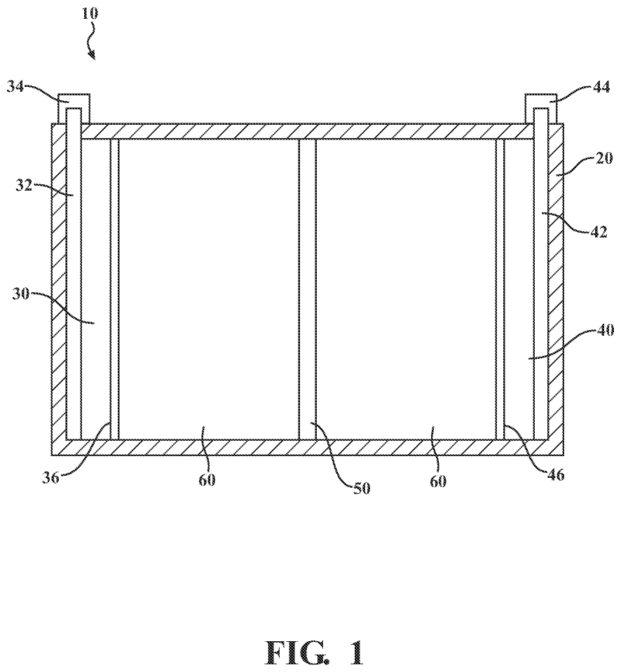

FIG. 1 schematically illustrates a lithium metal battery 10 including an electrolyte solution 60. The lithium metal battery 10 is illustrated including a cathode 30, an anode 40, a separator 50, and the electrolyte solution 60 taking up remaining space within a battery cell case 20 of the lithium metal battery 10. The lithium metal battery 10 is similar to a lithium-ion battery device used in the art, with one exception that the anode 40 of the lithium metal battery 10 is constructed with lithium metal instead of graphite. The electrolyte solution 60 surrounds and interacts with the cathode 30 and the anode 40. An SEI 36 including a solid layer forms upon the cathode 30, and an SEI 46 including a solid layer forms upon the anode 40. SEI 36 and SEI 46 are provided for illustration purposes. The actual thickness of either SEI 36 or SEI 46 may be significantly smaller than the corresponding electrode or microscopic. A current collector 32 is attached to cathode 30 and conducts electric charge between the cathode 30 and a positive battery terminal 34. A current collector 42 is attached to anode 40 and conducts electric charge between the anode 40 and a negative battery terminal 44. The electrolyte solution 60 includes the disclosed formulation, for example, including 0.5 M to 4 M LiFSI−[fluoroether solvent] (1%-99%)/0.1%-5% LFO/0.1%-40% FEC. The separator may be a polymer, a solid state separator, or another separator used in the art.

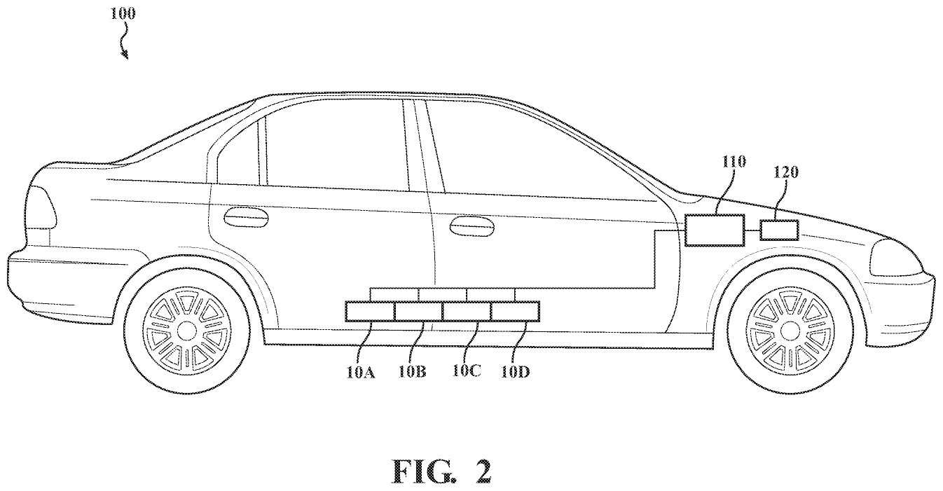

The lithium metal battery 10 may be used in isolation. In another embodiment, the lithium metal battery 10 may be used as one of a plurality of battery cells, with the plurality of battery cells being used together to provide energy storage for a system. FIG. 2 schematically illustrates vehicular system 100 including a plurality of battery cells 10A, 10B, 10C, and 10D. Each of the battery cells 10A, 10B, 10C, and 10D include a lithium metal battery 10. The battery cells 10A, 10B, 10C and 10D are provided as an exemplary plurality of battery cells that may be utilized to provide energy storage for the vehicular system 100. The battery cells 10A, 10B, 10C, and 10D provides electrical energy to electric machine 110 which is operable to supply an output torque useful to provide motive force to the vehicular system 100. The battery cells 10A, 10B, 10C, and 10D and the electric machine 110 are controlled by a computerized powertrain control device 120. The computerized powertrain control device 120 includes random-access memory (RAM), a computerized processor, and durable memory such as a hard drive and is useful to execute stored programming. The computerized powertrain control device 120 includes programming operable to control charging and discharging of the battery cells 10A, 10B, 10C, and 10D.

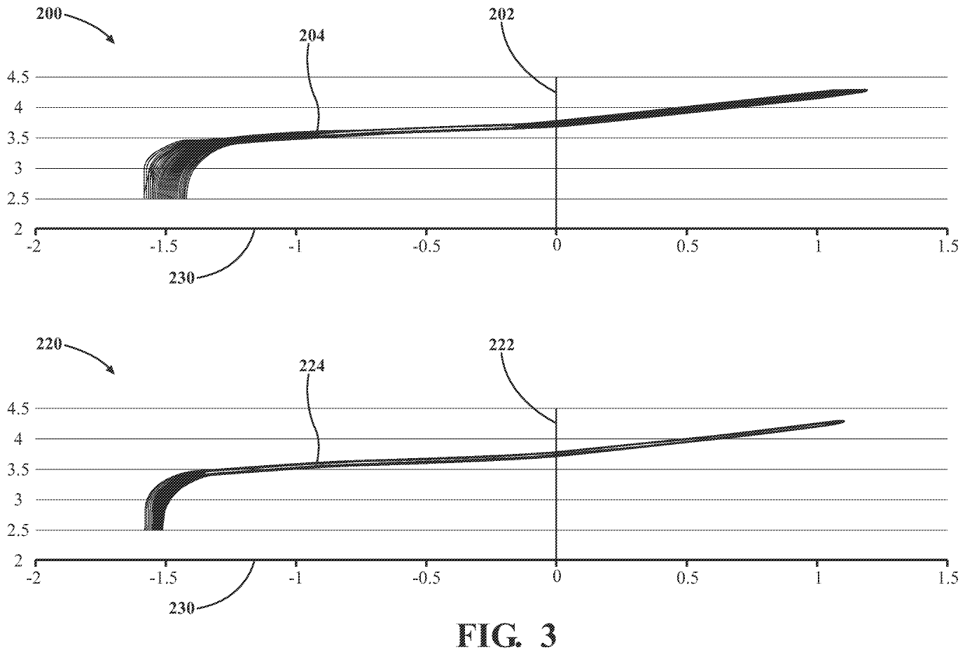

FIG. 3 is a graph illustrating performance of the electrolyte solution. A first portion 200 of the graph illustrates charge/discharge cycles of battery cell including an electrolyte solution using an EMC solvent and an LiPF₆ salt. A second portion 220 of the graph illustrates charge/discharge cycles of an electrolyte solution using the disclosed formulation. Each of the first portion 200 and the second portion 220 share a common horizontal axis 230 which illustrates battery capacity in amp hours.

The first portion 200 includes a vertical axis 202 which illustrates battery terminal voltage (V). Plot 204 illustrates operation of the battery cell including the electrolyte solution using an EMC solvent through multiple charging/discharging cycles. Initial cycles are illustrated to a left side of the plot, and as the number of cycles increase, the later cycles translate or walk to the right of the graph. This translation or walk to the right illustrate cyclical degradation of battery operation resulting from exhaustion of the electrodes and electrolyte solution.

The second portion 220 includes a vertical axis 222 which illustrates battery terminal voltage (V). Plot 224 illustrates operation of the battery cell including the disclosed formulation including the LFO additive through a same number of charging/discharging cycles as are illustrated in plot 204. Initial cycles are illustrated to a left side of the plot, and as the number of cycles increase, the later cycles translate or walk to the right of the graph. Comparison of the plot 224 to plot 204 illustrates that the disclosed formulation including the LFO additive include reduced translation to the right as a result of cyclical operation. The disclosed formulation slows the adverse effects of cyclical operation of the battery cell.

According to one embodiment, an electrolyte solution for a lithium metal battery is provided. The electrolyte solution includes lithium bis(fluorosulfonyl)imide dissolved in a fluorinated ether solvent, a first additive including fluoroethylene carbonate, and a second additive including lithium difluorophosphate.

In some embodiments, the fluorinated ether solvent is selected from one of fluorinated 1,4 dimethoxy butane; 1,1,2,2-tetrafluoroethyl 2,2,3,3-tetrafluoropropyl ether; 1,2,2,2-tetrafluoroethyl methyl ether; n-Butyl 1,1,2,2-tetrafluoroethyl ether; 1H,1H,2′H,3H-Decafluorodipropyl ether; bis(2,2,2-trifluoroethyl) ether; ethyl 1,1,2,2-tetrafluoroethyl ether; difluoromethyl 2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl) ether; 1,1,2,2-tetrafluoroethyl isobutyl ether; and 1,2-(1,1,2,2-tetrafluoroethoxy)-ethane.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

In some embodiments, the electrolyte solution further includes lithium hexafluorophosphate.

According to an alternative embodiment, a lithium metal battery is provided. The lithium metal battery includes an anode, a cathode, and a separator disposed between the anode and the cathode. The lithium metal battery further includes an electrolyte solution. The electrolyte solution includes lithium bis(fluorosulfonyl)imide dissolved in a fluorinated ether solvent, a first additive including fluoroethylene carbonate, and a second additive including lithium difluorophosphate.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

According to an alternative embodiment, a vehicular system operable by lithium metal battery is provided. The vehicular system includes an electrically powered vehicle and the lithium metal battery providing electrical energy to the electrically powered vehicle. The lithium metal battery includes an electrolyte solution. The electrolyte solution includes lithium bis(fluorosulfonyl)imide dissolved in a fluorinated ether solvent, a first additive including fluoroethylene carbonate, and a second additive including lithium difluorophosphate.

In some embodiments, the lithium bis(fluorosulfonyl)imide is present in an amount of from 0.5 moles per liter to 4 moles per liter based on 100 moles per liter of the fluorinated ether solvent.

In some embodiments, the first additive is present in an amount of from 0.1 part by weight to 40 parts by weight based upon 100 parts by weight of the electrolyte solution.

In some embodiments, the first additive is present in an amount of from 1 part by weight to 2 parts by weight based upon 100 parts by weight of the electrolyte solution.

In some embodiments, the second additive is present in an amount of from 0.1 part by weight to 5 parts by weight based upon 100 parts by weight of the electrolyte solution.

In some embodiments, the second additive is present in an amount of from 0.5 parts by weight to 2 parts by weight based upon 100 parts by weight of the electrolyte solution.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte solution for a lithium metal battery, the electrolyte solution comprising:
lithium bis(fluorosulfonyl)imide dissolved in a fluorinated ether solvent;
a first additive including fluoroethylene carbonate; and
a second additive including lithium difluorophosphate.

2. The electrolyte solution of claim 1, wherein the fluorinated ether solvent is selected from one of:
fluorinated 1,4 dimethoxy butane;
1,1,2,2-tetrafluoroethyl 2,2,3,3-tetrafluoropropyl ether;
1,2,2,2-tetrafluoroethyl methyl ether;
n-Butyl 1,1,2,2-tetrafluoroethyl ether;
1H,1H,2′H,3H-Decafluorodipropyl ether;
bis(2,2,2-trifluoroethyl) ether;
ethyl 1,1,2,2-tetrafluoroethyl ether;
difluoromethyl 2,2,3,3,3-pentafluoropropyl ether;
2,2,2-trifluoroethyl 1,1,2,2-tetrafluoroethyl ether;
difluoromethyl 2,2,3,3-tetrafluoropropyl ether;
propyl 1,1,2,2-tetrafluoroethyl ether;
1,1-difluoroethyl 2,2,2-trifluoroethyl ether;
isopropyl 1,1,2,2-tetrafluoroethyl ether;
bis(2,2-difluoroethyl) ether;
1,1,2,2-tetrafluoroethyl isobutyl ether; and
1,2-(1,1,2,2-tetrafluoroethoxy)-ethane.

3. The electrolyte solution of claim 1, wherein the lithium bis(fluorosulfonyl)imide is present in an amount of from 0.5 moles per liter to 4 moles per liter based on 100 moles per liter of the fluorinated ether solvent.

4. The electrolyte solution of claim 1, wherein the first additive is present in an amount of from 0.1 part by weight to 40 parts by weight based upon 100 parts by weight of the electrolyte solution.

5. The electrolyte solution of claim 1, wherein the first additive is present in an amount of from 1 part by weight to 2 parts by weight based upon 100 parts by weight of the electrolyte solution.

6. The electrolyte solution of claim 1, wherein the second additive is present in an amount of from 0.1 part by weight to 5 parts by weight based upon 100 parts by weight of the electrolyte solution.

7. The electrolyte solution of claim 1, wherein the second additive is present in an amount of from 0.5 parts by weight to 2 parts by weight based upon 100 parts by weight of the electrolyte solution.

8. The electrolyte solution of claim 1, further comprising lithium hexafluorophosphate.

9. A lithium metal battery comprising:
an anode;
a cathode;
a separator disposed between the anode and the cathode; and
an electrolyte solution, including:
lithium bis(fluorosulfonyl)imide dissolved in a fluorinated ether solvent;
a first additive including fluoroethylene carbonate; and
a second additive including lithium difluorophosphate.

10. The lithium metal battery of claim 9, wherein the lithium bis(fluorosulfonyl)imide is present in an amount of from 0.5 moles per liter to 4 moles per liter based on 100 moles per liter of the fluorinated ether solvent.

11. The lithium metal battery of claim 9, wherein the first additive is present in an amount of from 0.1 part by weight to 40 parts by weight based upon 100 parts by weight of the electrolyte solution.

12. The lithium metal battery of claim 9, wherein the first additive is present in an amount of from 1 part by weight to 2 parts by weight based upon 100 parts by weight of the electrolyte solution.

13. The lithium metal battery of claim 9, wherein the second additive is present in an amount of from 0.1 part by weight to 5 parts by weight based upon 100 parts by weight of the electrolyte solution.

14. The lithium metal battery of claim 9, wherein the second additive is present in an amount of from 0.5 parts by weight to 2 parts by weight based upon 100 parts by weight of the electrolyte solution.

15. A vehicular system operable by lithium metal battery, the vehicular system comprising:
an electrically powered vehicle;
the lithium metal battery providing electrical energy to the electrically powered vehicle and including an electrolyte solution that includes:
lithium bis(fluorosulfonyl)imide dissolved in a fluorinated ether solvent;
a first additive including fluoroethylene carbonate; and
a second additive including lithium difluorophosphate.

16. The vehicular system of claim 15, wherein the lithium bis(fluorosulfonyl)imide is present in an amount of from 0.5 moles per liter to 4 moles per liter based on 100 moles per liter of the fluorinated ether solvent.

17. The vehicular system of claim 15, wherein the first additive is present in an amount of from 0.1 part by weight to 40 parts by weight based upon 100 parts by weight of the electrolyte solution.

18. The vehicular system of claim 15, wherein the first additive is present in an amount of from 1 part by weight to 2 parts by weight based upon 100 parts by weight of the electrolyte solution.

19. The vehicular system of claim 15, wherein the second additive is present in an amount of from 0.1 part by weight to 5 parts by weight based upon 100 parts by weight of the electrolyte solution.

20. The vehicular system of claim 15, wherein the second additive is present in an amount of from 0.5 parts by weight to 2 parts by weight based upon 100 parts by weight of the electrolyte solution.
